(19) United States
(12) Patent Application Publication
(10) Pub. No.: US 2024/0236861 A1
(43) Pub. Date: Jul. 11, 2024

(54) APPARATUS FOR REPORTING APPLICATION PROCESS STATUS AND OPERATING METHOD THEREOF

(71) Applicant: Samsung Electronics Co., Ltd., Gyeonggi-do (KR)

(72) Inventors: Deokhui LEE, Gyeonggi-do (KR); Dongmyung KIM, Gyeonggi-do (KR); Wonjun KIM, Gyeonggi-do (KR); Sangho LEE, Gyeonggi-do (KR); Juho LEE, Gyeonggi-do (KR)

(21) Appl. No.: 18/407,978

(22) Filed: Jan. 9, 2024

(30) Foreign Application Priority Data
Jan. 9, 2023 (KR) 10-2023-0003125

(51) Int. Cl. H04W 52/02; H04W 76/20

(52) U.S. Cl. CPC H04W 52/0251; H04W 76/20

(57) ABSTRACT

The disclosure relates to a 5G communication system or a 6G communication system for supporting higher data rates beyond a 4G communication system such as long term evolution (LTE). Disclosed is a method performed by a terminal, which includes generating application process state (APS) information indicating whether data generated by at least one application of the terminal is data generated in a background process or data generated in a foreground process; and transmitting a control signal including the APS information to a base station.

### CROSS-REFERENCE TO RELATED APPLICATION(S)

This application is based on and claims priority under 35 U.S.C. § 119 to Korean Patent Application No. 10-2023-0003125, filed on Jan. 9, 2023, in the Korean Intellectual Property Office, the disclosure of which is incorporated herein by reference in its entirety.

### BACKGROUND

### 1. Field

The disclosure relates generally to a wireless communication system, and more particularly, to a method and an apparatus for reporting an application process status in a wireless communication system.

### DESCRIPTION OF RELATED ART

Given the rapid development of wireless communication, technologies have primarily been developed for services targeting humans, such as voice calls, multimedia services, and data services. As fifth generation (5G) communication systems have been commercialized, a continuous increase in the number of connected devices and communication networks is occurring.

Examples of such connected devices may include vehicles, robots, drones, home appliances, displays, smart sensors connected to various infrastructures, construction machines, and factory equipment. Mobile devices are expected to evolve in various forms, such as augmented reality glasses, virtual reality headsets, and hologram devices. To provide various services by connecting hundreds of billions of devices and things in the sixth generation (6G) era, there have been ongoing efforts to develop improved 6G communication systems, also referred to as beyond-5G systems.

6G communication systems, which are expected to be commercialized around 2030, will have a peak data rate of 1 terabit per second (Tbps)-level and a radio latency less than 100 microseconds (μsec), and thus will be 50 times as fast as 5G communication systems and have 1/10 the radio latency thereof.

To accomplish such a high data rate and an ultra-low latency, it has been considered to implement 6G communication systems in the THz band, such as 95 gigahertz (GHz) to 3 THz bands. It is expected that, due to severe path loss and atmospheric absorption in the THz bands than those in the millimeter wave (mmWave) bands introduced in 5G, the importance of technologies capable of securing the signal transmission coverage will increase. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of THz-band signals, such as metamaterial-based lenses and antennas, orbital angular momentum (OAM), and reconfigurable intelligent surface (RIS).

To improve the spectral efficiency and the overall network performances, the following technologies have been developed for 6G communication systems: a full-duplex technology for enabling an uplink (UL) transmission and a downlink (DL) transmission to simultaneously use the same frequency resource, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of UE computing ability through reachable super-high-performance communication and computing resources (such as mobile edge computing (MEC), clouds, and the like) over the network. By designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will enable the next hyper-connected experience to transpire. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

In 4^{th} generation (4G)/5G mobile communication systems, if a user equipment (UE) transits from a radio resource control (RRC) idle (RRC_IDLE) state or an RRC inactive (RRC_INACTIVE) state into an RRC connected (RRC_CONNECTED) state, the UE performs a secondary cell (SCell) (or secondary node) addition procedure based on a blind addition scheme for a carrier aggregation (CA) and/or dual connectivity (DC) operation. In the blind addition scheme, a base station may add an SCell (or secondary node) without a measurement result and/or buffer information.

CA and/or DC connections based on the blind addition scheme may have low latency to reach maximum throughput. However, if the UE transits from the RRC_IDLE state or the RRC_INACTIVE state into the RRC_CONNECTED state for transmitting a minimal amount of data which is less than a threshold data size, or for data transmission for short duration which is less than threshold duration, the CA and/or DC connections may be unnecessarily maintained, thereby causing an unnecessary battery consumption in the electronic device.

### SUMMARY

This disclosure has been made to address at least the above-mentioned problems and/or disadvantages and to provide at least the advantages described below.

Accordingly, an aspect of the disclosure is to provide In accordance with an aspect of the disclosure, a terminal includes a transceiver, and a processor operably connected to the transceiver, wherein the processor is configured to generate application process state (APS) information indicating whether data generated by at least one application of the terminal is data generated in a background process or data generated in a foreground process, and transmit, via the transceiver, a control signal including the APS information to a base station.

In accordance with an aspect of the disclosure, a method performed by a terminal includes generating APS information indicating whether data generated by at least one application of the terminal is data generated in a background process or data generated in a foreground process, and transmitting a control signal including the APS information to a base station.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a wireless network according to an embodiment;

FIG. 2 illustrates a gNB according to an embodiment;

FIG. 3 illustrates a UE according to an embodiment;

FIG. 4 illustrates a battery consumption of a UE according to an SCell addition procedure or an SgNB addition procedure based on a blind addition scheme to which the disclosure is applied;

FIG. 5 illustrates a battery consumption of a UE according to an SgNB addition procedure based on a blind addition scheme to which the disclosure is applied;

FIG. 6 illustrates a battery consumption of a UE in an SDT procedure to which the disclosure is applied;

FIG. 7 illustrates a battery consumption of a UE in a non-SDT procedure to which the disclosure is applied;

FIG. 8A illustrates a format of BSR information according to an embodiment;

FIG. 8B illustrates a format of BSR information according to an embodiment;

FIG. 8C illustrates a format of BSR information according to an embodiment;

FIG. 9A illustrates a format of BSR information according to an embodiment;

FIG. 9B illustrates a format of BSR information according to an embodiment;

FIG. 9C illustrates a format of BSR information according to an embodiment;

FIG. 10A illustrates a format of BSR information according to an embodiment;

FIG. 10B illustrates a format of BSR information according to an embodiment;

FIG. 11 illustrates a procedure between a UE and an eNB for providing APS information in a wireless communication system according to an embodiment;

FIG. 12 illustrates a procedure between a UE and an eNB for providing APS information in a wireless communication system according to an embodiment;

FIG. 13 illustrates an SCell addition procedure for a CA operation and/or a DC operation in a wireless communication system according to an embodiment; and

FIG. 14 illustrates an SgNB addition procedure for a CA operation and/or a DC operation in a wireless communication system according to an embodiment.

### DETAILED DESCRIPTION

Hereinafter, embodiments of the disclosure will be described in detail in reference to the accompanying drawings. A detailed description of relevant known functions or configurations incorporated herein will be omitted when it is determined that the description may make the subject matter of an embodiment of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Embodiments of the disclosure and the terms used therein are not intended to limit the technological features set forth herein to particular embodiments and include various changes, equivalents, or replacements for a corresponding embodiment. In the description of the drawings, similar reference numerals may be used to refer to similar or related elements. It is to be understood that a singular form of a noun corresponding to an item may include one or more of the things unless the relevant context clearly indicates otherwise. As used herein, each of such phrases as A or B, at least one of A and B, at least one of A or B, A, B, or C, at least one of A, B, and C, and at least one of A, B, or C, may include any one of, or all possible combinations of the items enumerated together in a corresponding one of the phrases. As used herein, such terms as 1^{st} and 2^{nd}, or first and second may be used to simply distinguish a corresponding component from another, and do not limit the components in other aspect (e.g., importance or order). It is to be understood that if an element (e.g., a first element) is referred to, with or without the term operatively or communicatively, as coupled with, coupled to, connected with, or connected to another element (e.g., a second element), it indicates that the element may be coupled with the other element directly (e.g., wiredly), wirelessly, or via a third element.

Herein, the term couple and its derivatives refer to any direct or indirect communication between two or more elements, whether those elements are in physical contact with one another. The terms transmit, receive, and communicate, as well as derivatives thereof, encompass both direct and indirect communication. The terms include and comprise, as well as derivatives thereof, mean inclusion without limitation. The term or is inclusive, meaning and/or. The phrase associated with, as well as derivatives thereof, indicates to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term controller indicates any device, system or part thereof that controls at least one operation. Such a controller may be implemented in hardware or a combination of hardware and software and/or firmware. The functionality associated with any particular controller may be centralized or distributed, whether locally or remotely. The phrase at least one of, when used with a list of items, indicates that different combinations of one or more of the listed items may be used, and only one item in the list may be needed.

Technical terms used herein are only used to describe a specific embodiment and are not intended to limit the disclosure but should be interpreted to have the same meaning as those commonly understood by a person skilled in the art to which the disclosure pertains, and should not be interpreted have excessively comprehensive or excessively restricted meanings unless particularly defined as other meanings. The general terms used herein should be interpreted as defined in dictionaries or in the context of the relevant part, and should not be interpreted to have excessively restricted meanings.

A singular expression used herein may include a plural expression unless they are definitely different in the context. As used herein, such a term as “comprises or include should not be interpreted to necessarily include all elements or all operations described in the specification and should be interpreted to be enabled to exclude some of them or further include additional elements or operations.

When an element is referred to as being connected or coupled to another element, it may be connected or coupled directly to the other element, or any other element may be interposed between them. In contrast, when an element is referred to as being directly connected or directly coupled to another element, no element is interposed between them.

Regardless of drawing signs, the same or like elements are provided with the same reference numeral, and a repeated description thereof will be omitted.

The discussion of 5G systems and frequency bands associated therewith is for reference as certain embodiments may be implemented in 5G systems. However, the disclosure is not limited thereto, and embodiments may be utilized in connection with any frequency band, such as those in a 6G communication system or even later releases which may use THz bands.

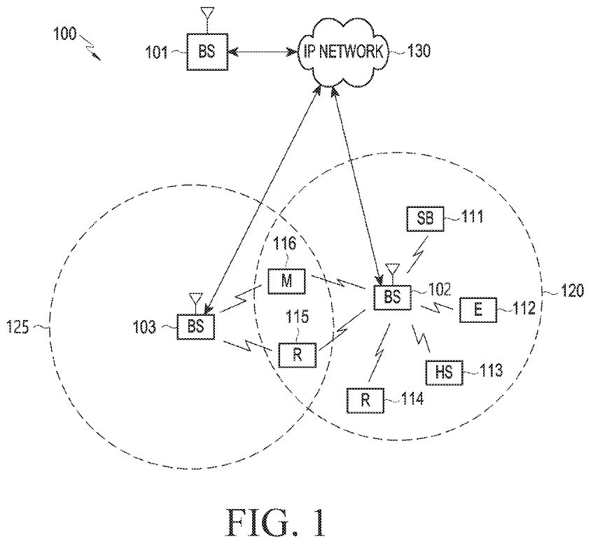

FIG. 1 illustrates a wireless network 100 according to an embodiment.

In FIG. 1, the wireless network 100 includes a gNB 101 (e.g., base station (BS)), a gNB 102, and a gNB 103. The gNB 101 communicates with the gNB 102 and the gNB 103. The gNB 101 also communicates with at least one network 130, such as the Internet, a proprietary Internet protocol (IP) network, or other data network.

The gNB 102 provides wireless broadband access to the network 130 for a first plurality of UEs within a coverage area 120 of the gNB 102. The UE may also be referred to as an electronic device, a terminal, a mobile station, a mobile equipment (ME), a user terminal (UT), a subscriber station (SS), a wireless device, a handheld device, and an access terminal (AT). Alternatively, the UE may have a communication function such as, for example, a mobile phone, a personal digital assistant (PDA), a smart phone, a wireless modulation/demodulation device (MODEM), and a notebook. The first plurality of UEs include a UE 111, which may be located in a small business (SB), a UE 112, which may be located in an enterprise (E); a UE 113, which may be located in a wireless fidelity (WiFi) hotspot (HS); a UE 114, which may be located in a first residence (R), a UE 115, which may be located in a second residence (R), and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. One or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term base station or BS can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. The BS may provide wireless access in accordance with one or more wireless communication protocols, e.g., 5G/NR 3GPP NR, LTE, LTE-A, high speed packet access (HSPA), Wi-Fi 802.11, etc. For the sake of convenience, the terms BS and TRP are used interchangeably herein to refer to network infrastructure components that provide a wireless access to remote terminals. Depending on the network type, the term user equipment or UE can refer to any component such as mobile station, subscriber station, remote terminal, wireless terminal, receive point, or user device. For the sake of convenience, the terms user equipment and UE are used herein to refer to remote wireless equipment that wirelessly accesses a BS, whether the UE is a mobile device (such as a mobile telephone or smartphone) or is normally considered a stationary device (such as a desktop computer or vending machine). For example, a UE could be a mobile telephone, a smartphone, a monitoring device, an alarm device, a fleet management device, an asset tracking device, an automobile, a desktop computer, an entertainment device, an infotainment device, a vending machine, an electricity meter, a water meter, a gas meter, a security device, a sensor device, an appliance, and the like.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

One or more of the UEs 111-116 include circuitry, programming, or a combination thereof for channel state information (CSI) measurement and report outside active DL bandwidth part (BWP). In certain embodiments, one or more of the gNBs 101-103 includes circuitry, programming, or a combination thereof for CSI measurement and report outside active DL BWP.

Various changes may be made to FIG. 1. For example, the wireless network could include any number of gNBs and any number of UEs in any suitable arrangement. The gNB 101 could communicate directly with any number of UEs and provide those UEs with wireless broadband access to the network 130. Similarly, each gNB 102-103 could communicate directly with the network 130 and provide UEs with direct wireless broadband access to the network 130. The gNBs 101, 102, and/or 103 could provide access to other or additional external networks, such as external telephone networks or other types of data networks.

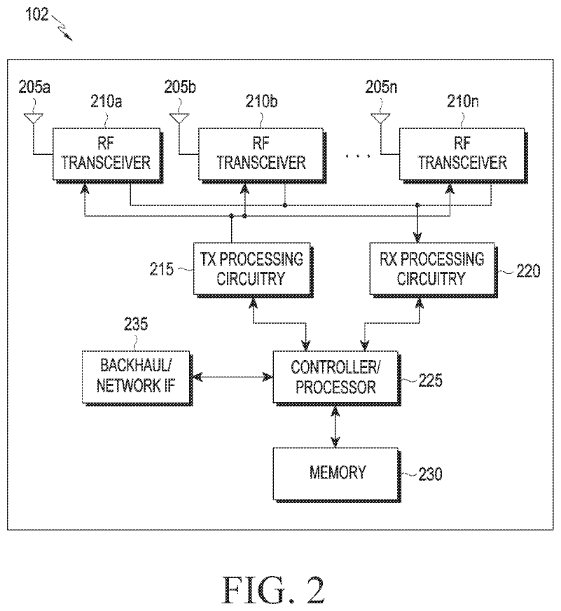

FIG. 2 illustrates a gNB 102 according to an embodiment.

In FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225 and encodes, multiplexes, and/or digitizes the outgoing baseband data to generate processed baseband or IF signals. The RF transceivers 210a-210n receive the outgoing processed baseband or IF signals from the TX processing circuitry 215 and up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support assisted sensing for CSI measurements. Numerous other functions could be supported in the gNB 102 by the controller/processor 225, which includes at least one microprocessor or microcontroller.

The controller/processor 225 is also capable of executing programs and other processes resident in the memory 230, such as an OS, and can transport data into or out of the memory 230 as required by an executing process. The controller/processor 225 supports communication between entities.

The controller/processor 225 is also coupled to the backhaul or network interface 235 which enables the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could enable the gNB 102 to communicate with other gNBs over a wired or wireless backhaul connection. When the gNB 102 is implemented as an access point, the interface 235 could enable the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. While shown as including a single instance of TX processing circuitry 215 and a single instance of RX processing circuitry 220, the gNB 102 could include multiple instances of each (such as one per RF transceiver). Various components in FIG. 2 could be combined, further subdivided, or omitted and additional components could be added according to particular needs.

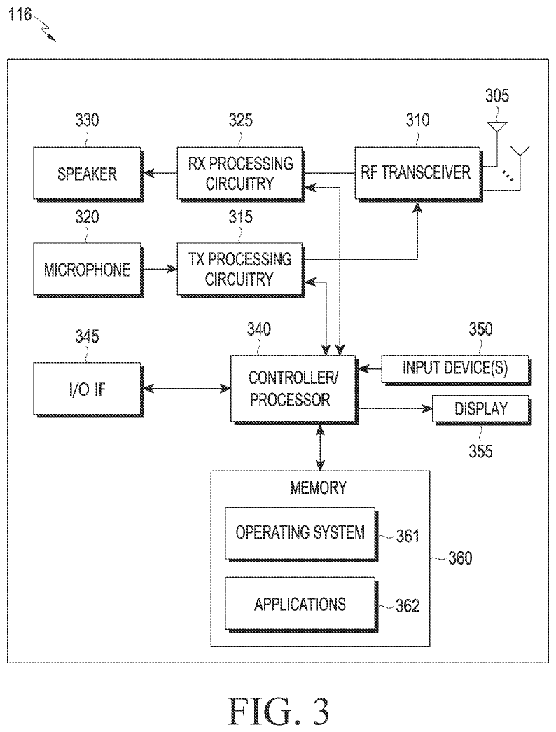

FIG. 3 illustrates a UE 116 according to an embodiment.

In FIG. 3, the UE 116 includes an antenna 305, an RF transceiver 310, TX processing circuitry 315, a microphone 320, and RX processing circuitry 325. The UE 116 also includes a speaker 330, a controller/processor 340, an input/output (I/O) interface (IF) 345, an input device 350, a display 355, and a memory 360. The memory 360 includes an OS 361 and one or more applications 362. The controller/processor 340 may be a processor, and the processor may include at least one of an application processor or a communication processor (CP). The processor may be implemented in a form in which the AP and the CP are integrated.

The RF transceiver 310 receives, from the antenna 305, an incoming RF signal transmitted by a gNB of the network 100 and down-converts the incoming RF signal to generate an intermediate frequency or baseband signal. The IF or baseband signal is sent to the RX processing circuitry 325, which generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or IF signal to an RF signal that is transmitted via the antenna 305.

The controller/processor 340 can include one or more processors or other processing devices and execute the OS 361 stored in the memory 360 to control the overall operation of the UE 116. For example, the controller/processor 340 could control the reception of forward channel signals and the transmission of reverse channel signals by the RF transceiver 310, the RX processing circuitry 325, and the TX processing circuitry 315 in accordance with well-known principles. The controller/processor 340 includes at least one microprocessor or microcontroller.

The controller/processor 340 is also capable of executing other processes and programs resident in the memory 360, such as processes for beam management. The controller/processor 340 can transport data into or out of the memory 360 as required by an executing process. The processor 340 is configured to execute the applications 362 based on the OS 361 or in response to signals received from gNBs or an operator. The controller/processor 340 is also coupled to the I/O interface 345, which enables the UE 116 to connect to other devices, such as laptop computers and handheld computers. The I/O interface 345 is the communication path between these accessories and the processor 340.

The controller/processor 340 is also coupled to the input device 350 and the display 355. The operator of the UE 116 can use the input device 350 to enter data into the UE 116. The input device 350 can be a keyboard, touchscreen, mouse, track ball, voice input, or other device capable of acting as a user interface to enable a user in interact with the UE 116. The input device 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme.

The controller/processor 340 is also coupled to the display 355. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the controller/processor 340 could be divided into multiple processors, such as one or more central processing units (CPUs) and one or more graphics processing units (GPUs). While FIG. 3 illustrates the UE 116 configured as a mobile telephone or smartphone, UEs could be configured to operate as other types of mobile or stationary devices.

More particularly, in 4^{th} generation (4G)/5G mobile communication systems, if a UE transits from a radio resource control (RRC) idle (RRC_IDLE) state or an RRC inactive (RRC_INACTIVE) state into an RRC connected (RRC_CONNECTED) state, the UE performs a secondary cell (SCell) (or secondary node) addition procedure based on a blind addition scheme for a CA and/or DC operation. In the blind addition scheme, a base station may add an SCell (or secondary node) without a measurement result and/or buffer information.

If the UE is in the RRC_CONNECTED state, the base station may identify the number of SCells for CA and whether to perform a DC operation based on various parameters such as an average value or trend of electric field information and/or buffer information.

However, if the UE is in the RRC_IDLE state or the RRC_INACTIVE state, there may not be a useful parameter which the base station may use to identify the number of SCells for the CA and whether to perform the DC operation.

For example, if the UE transits from the RRC_IDLE state or the RRC_INACTIVE state into the RRC_CONNECTED state, the UE may perform the SCell addition procedure for the CA based on the blind addition scheme. Because the SCell addition procedure is performed based on the blind addition scheme, the UE may perform the SCell addition procedure without using a measurement result in an SCell. If the UE adds a plurality of SCells for transmitting a minimal amount of data which is less than a threshold data size, or for data transmission for short duration which is less than threshold duration, the UE may need to maintain the added SCells until the added SCells are released (for example, until an SCell release message for each of the added SCells is received from the base station). SCell release timing for releasing an SCell may be determined by the base station, and the base station may determine the SCell release timing based on buffer information (e.g., buffer occupancy) and/or a timer. Although the base station may receive, from the UE which is in the RRC_INACTIVE state, electric field information (e.g., at least one of reference signal received power (RSRP), a received strength signal indicator (RSSI), reference signal received quality (RSRQ), received signal code power (RSCP), a signal to noise ratio (SNR), or a signal to interference plus noise ratio (SINR)) and/or buffer information (e.g., buffer status report (BSR)) through an attach procedure, the electric field information and/or buffer information is fragmentary information, so it may be difficult for the base station to identify the number of SCells for the CA and whether to perform the DC operation based on the fragmentary information. Thus, unnecessary CA for the UE may be maintained, which unnecessarily increases battery consumption of the UE.

Thus, there is a need in the art for a method and apparatus which mitigate this unnecessary use of critical resources in the electronic device.

When transiting from the RRC_IDLE state or the RRC_INACTIVE state into the RRC_CONNECTED state, the UE may perform a secondary node (e.g., secondary gNB (SgNB)) addition procedure based on the blind addition scheme, for DC (e.g., EN-DC (E-UTRA NR Dual Connectivity with E-UTRA connected to EPC). In this case, the base station (e.g., the eNB) may configure a B1 measurement report in a blind scheme after an LTE attach procedure of the UE is completed. So, if a B1 measurement report for another base station (e.g., an SgNB) is received from the UE, the SgNB addition procedure may be immediately performed.

If the UE adds a plurality of SgNBs for transmitting small data which is less than a threshold data size, or for data transmission for a short duration which is less than a threshold duration, the UE may need to maintain the added SgNBs until the added SgNBs are released, such as when a set inactivity timer expires. Therefore, an unnecessary DC operation for the UE may be maintained, which may increase battery consumption of the UE.

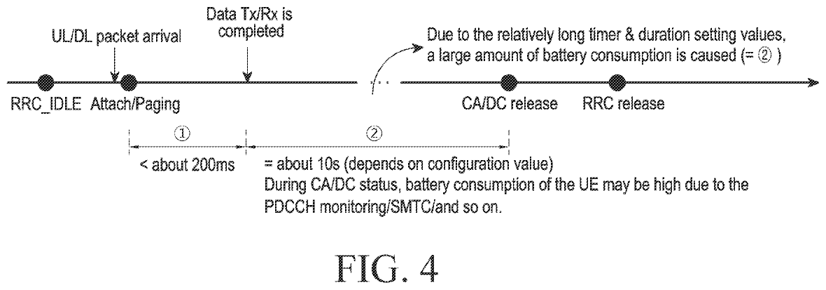

FIG. 4 illustrates a battery consumption of a UE according to an SCell addition procedure or an SgNB addition procedure based on a blind addition scheme to which the disclosure is applied.

Referring to FIG. 4, if an SCell addition procedure is performed for CA, a base station (e.g., an eNB) may maintain (\textcircled{2}) an added (at least one) SCell until a size of data which stored in a buffer for duration exceeding threshold duration (e.g., the threshold duration may be set to 10 s) is less than a threshold data size. If an SgNB addition procedure is performed for a DC operation (e.g., an EN-DC operation), a base station (e.g., a gNB) may maintain (\textcircled{2}) a 5G connection (e.g., an added SgNB) between a UE and the gNB until an inactivity timer (for example, a timer value of the inactivity timer may be set to 10 s) expires.

That is, even though actual data transmission/reception for the UE is completed (\textcircled{1}) for relatively short duration (e.g., 200 ms), an SCell or SgNB may be maintained unnecessarily (\textcircled{2}), thereby causing power consumption in the UE to unnecessarily increase.

To prevent the SgNB from being unnecessarily maintained in the SgNB addition procedure based on the blind addition scheme as described in FIG. 4, the application processor may transmit a secondary cell group (SCG) failure information (SCGFailureInformation) message to the base station. If the base station receives the SCGFailureInformation message, the added SgNB may be released immediately. However, because the SCGFailureInformation message is transmitted even though an SCG failure has not actually occurred, key performance indicator (KPI) deterioration may occur, and the base station may reconfigure an RRC connection to receive a B1 measurement report, but the UE may not transmit the B1 Measurement report.

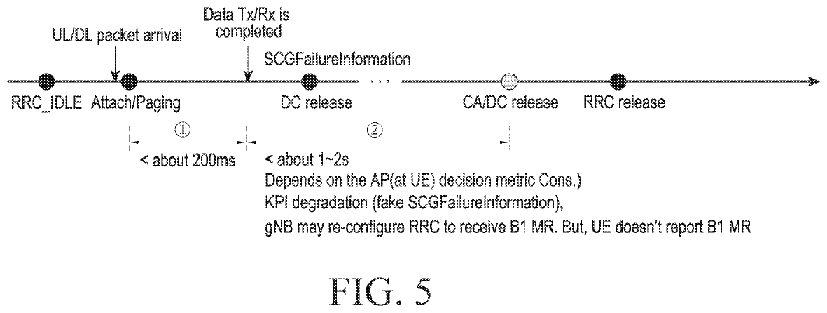

FIG. 5 illustrates a battery consumption of a UE according to an SgNB addition procedure based on a blind addition scheme to which the disclosure is applied.

Referring to FIG. 5, if an SgNB addition procedure is performed for a DC operation (e.g., an EN-DC operation), a base station (e.g., a gNB) may maintain a 5G connection (e.g., an added SgNB) between a UE and the gNB until an inactivity timer (for example, a timer value of the inactivity timer may be set to 10 s) expires. That is, even though actual data transmission/reception for the UE is completed (\textcircled{1}) for relatively short duration (e.g., 200 ms), an SCell or SgNB may be unnecessarily maintained.

Because the SgNB is unnecessarily maintained, power consumption in the UE may increase, so the application processor of the UE may transmit an SCGFailureInformation message to the base station. If the base station receives the SCGFailureInformation message, the added SgNB may be released immediately. However, because the SCGFailureInformation message is transmitted even though an SCG failure has not actually occurred, KPI deterioration may occur, and the base station may reconfigure an RRC connection to receive a B1 measurement report, but the UE may not transmit the B1 Measurement report (\textcircled{2}).

A small data transmission (SDT) procedure has been disclosed to reduce power consumption in a UE which is in an RRC_INACTIVE state. Abase station (e.g., an eNB and/or a gNB) may identify whether to perform the SDT procedure based on a UL and/DL data size. If the UL/DL buffer size is less than or equal to a threshold data size for triggering the SDT procedure, the SDT procedure may be performed.

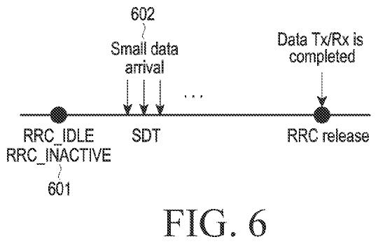

FIG. 6 illustrates a battery consumption of a UE according to an SDT procedure to which the disclosure is applied.

Referring to FIG. 6, when data 602 is generated, a UE in an RRC_INACTIVE state 601 may determine whether to initiate an SDT procedure or a non-SDT procedure based on a threshold data size. For example, if a size of the generated data 602 is less than or equal to the threshold data size, the UE may determine to perform the SDT procedure in the RRC_INACTIVE state 601. Alternatively, if the size of the generated data 602 exceeds the threshold data size, the UE may determine to perform the non-SDT procedure, transition from the RRC_INACTIVE state 601 to an RRC_CONNECTED state, and perform the non-SDT procedure in the RRC_CONNECTED state.

As described in FIG. 6, if the UE in the RRC_INACTIVE state performs the SDT procedure, no additional power consumption may occur. However, if the UL/DL size of the generated data exceeds the threshold data size for triggering the SDT procedure, the SDT procedure may not be performed. In this case, a power consumption issue in the UE may still exist, and the power consumption effect in the UE according to the SDT procedure may not be expected because the RRC_INACTIVE state is not supported in a non-standalone (NSA) architecture.

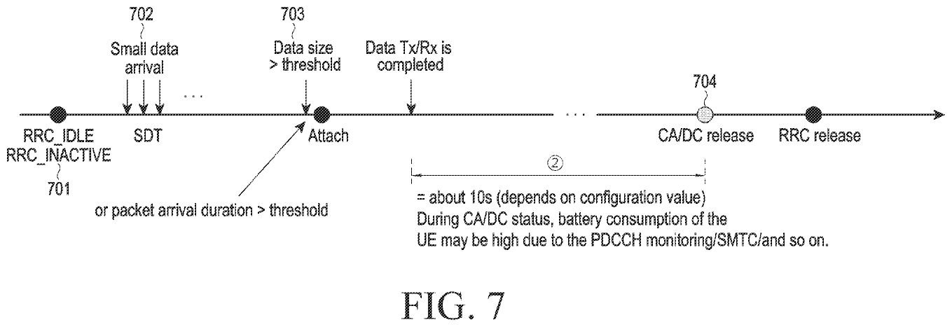

FIG. 7 illustrates a battery consumption of a UE according to a non-SDT procedure to which the disclosure is applied.

Referring to FIG. 7, when data 702 is generated, a UE in an RRC_INACTIVE state 701 may determine whether to initiate an SDT procedure or a non-SDT procedure based on a threshold data size. For example, if a size of the generated data 702 is less than or equal to the threshold data size 703, the UE may determine to perform the SDT procedure and perform the SDT procedure in the RRC_INACTIVE state 701. Alternatively, if the size of the generated data exceeds the threshold data size 703, the UE may determine to perform the non-SDT procedure, transition (CA/DC release) 704 from the RRC_INACTIVE state to an RRC_CONNECTED state, and perform the non-SDT procedure in the RRC_CONNECTED state.

If the size of the generated data exceeds the threshold data size for triggering the SDT procedure even though the SDT procedure is performed, the non-SDT procedure is performed, so CA and/or DC operations according to the non-SDT procedure may be performed, which may result in (\textcircled{2}) excess battery consumption of the UE according to an SCell addition procedure or an SgNB addition procedure based on a blind addition scheme, as described in FIG. 4.

It is highly important to reduce excess battery consumption in a UE, which makes it important to prevent maintaining an unnecessary SCell or SgNB.

An embodiment herein discloses an application process state (APS) parameter indicating APS.

When data is generated by a single application, an APS parameter for a specific logical channel identifier (LCID) or a specific logical channel group (LCG) identifier (ID) may be expressed as shown below in Table 1.

TABLE 1

| Value | Description |
|---|---|
| 0 | Data is generated w/ application in background process |
| 1 | Data is generated w/ application in foreground process |

As shown in Table 1, the APS parameter may be implemented with, for example, 1 bit. I a value of the APS parameter is a first value (e.g., 0), this may indicate that data is generated by an application in a background process (Data is generated w/application in background process) which runs regardless of input.

If the value of the APS parameter is a second value (e.g., 1), this may indicate that data is generated by an application in a foreground process (Data is generated w/application in foreground process) which has to wait for execution to end after a command is entered. For example, the foreground process may include a process of an application which includes an instance (e.g., a user interface (UI) shell) through which a user may intervene.

When data is generated by a plurality of applications, an APS parameter for a specific LCID or specific LCG ID may be expressed as shown below in Table 2.

TABLE 2

| Value | Description |
|---|---|
| 0 | Data is generated w/application in background |
| | process |
| 1 | Alt. 1) Data is generated w/application in |
| | foreground process |
| | Alt. 2) Data is generated w/all applications in |
| | background process. At the same time, |
| | foreground process (which doesn't generate |
| | data) is running |

As shown in Table 2, the APS parameter may be implemented with, for example, 1 bit. If a value of the APS parameter is a first value (e.g., 0), this may indicate that data is generated by all applications in a background process (Data is generated w/all applications in background process).

If the value of the APS parameter is a second value (e.g., 1), this may indicate that data is generated by at least one application in a foreground process (Data is generated w/at least one application in foreground process) (Alt. 1). The at least one application may be at least one of the plurality of applications.

If the value of the APS parameter is a second value (e.g., 1), this may indicate that data is generated by all applications in the background process, and the foreground process (which does not generate data) is running at the same time (Data is generated w/all applications in background process. At the same time, the foreground process (which doesn't generate data) is running) (Alt. 2).

A UE may report an APS parameter per buffer status report (BSR) information. So, a base station (eNB and/or gNB) may utilize network management when the UE transits from an RRC_IDLE state or an RRC_INACTIVE state to an RRC_CONNECTED state based on the APS parameter reported from the UE.

The base station may prevent the UE from performing CA and/or DC operations to transmit data generated by a background process based on the APS parameter, thereby reducing power consumption in the UE.

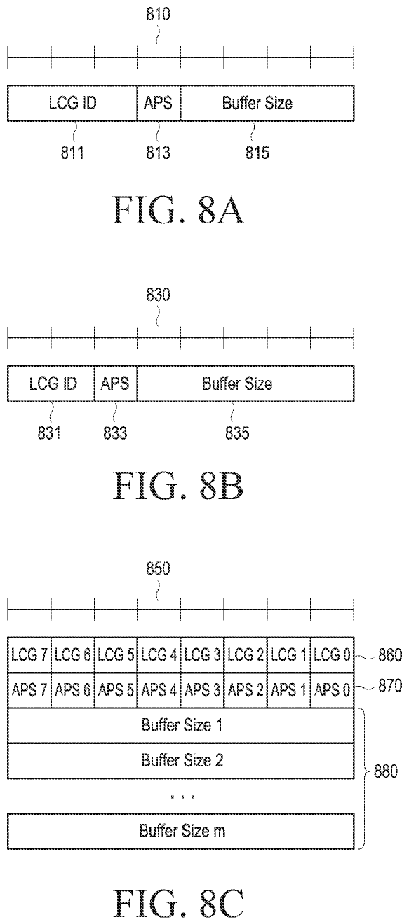

FIG. 8A illustrates a format of BSR information according to an embodiment.

Referring to FIG. 8A, a buffer status reporting procedure may be a procedure used to provide a serving base station (e.g., a serving eNB or a serving gNB) with information about UL data volume (or a UL data size) in a medium access control (MAC) entity, and BSR information may be implemented with, for example, a BSR MAC control element (CE). The BSR MAC CE may have a first format (e.g., a short BSR format) or a second format (e.g., a long BSR format), and it will be noted that a BSR MAC CE 810 implemented in the short BSR format is shown in FIG. 8A. The short BSR format may have a fixed size, and the long BSR format may have a variable size.

The BSR MAC CE 810 may include at least one of an LCG ID field 811, an APS field 813, and a buffer size field 815.

The LCG ID field 811 may include an LCG ID which identifies a group of logical channel(s) for which buffer status is reported. The LCG ID field 811 may be implemented with, for example, 3 bits.

The APS field 813 may include an APS parameter, and the APS parameter may be implemented similarly or substantially the same as described in Table 1 or Table 2, so a detailed description thereof will be omitted herein. The APS field 813 may be implemented with, for example, 1 bit.

The buffer size field 815 may indicate a total amount of available data according to a data volume calculating procedure across all logical channels of a corresponding logical channel group after data (e.g., a MAC protocol data unit (PDU)) is generated. For example, an amount of data may be indicated by the number of bytes. A size of radio link control (RLC) headers and MAC subheaders is not considered when calculating a buffer size. The buffer size field 815 may be implemented with, for example, 4 bits.

FIG. 8B illustrates a format of BSR information according to an embodiment.

Referring to FIG. 8B, BSR information may be implemented as a BSR MAC CE 830 with a short BSR format.

The BSR MAC CE 830 may include at least one of an LCG ID field 831, an APS field 833, and a buffer size field 835.

The LCG ID field 831 may include an LCG ID that identifies a group of logical channel(s) for which buffer status is reported. The LCG ID field 831 may be implemented with, for example, 2 bits.

The APS field 833 may include an APS parameter, and the APS parameter may be implemented similarly or substantially the same as described in Table 1 or Table 2, so a detailed description thereof will be omitted herein. The APS field 833 may be implemented with, for example, 1 bit.

The buffer size field 835 may indicate a buffer size corresponding to an LCG indicated by the LCG ID field 831, for example, total amount of available data according to a data volume calculating procedure across all logical channels of a corresponding logical channel group after data (e.g., a MAC PDU) is generated. For example, an amount of data may be indicated by the number of bytes. A size of RLC headers and MAC subheaders is not considered when calculating a buffer size. The buffer size field 835 may be implemented with, for example, 5 bits.

Both the BSR MAC CE 810 illustrated in FIG. 8A and the BSR MAC CE 830 illustrated in FIG. 8B may have the short BSR format. However, the number of bits of the LCG ID field 811 included in the BSR MAC CE 810 may be different from the number of bits of the LCG ID field 831 included in the BSR MAC CE 830, and the number of bits of the buffer size field 815 included in the BSR MAC CE 810 may be different from the number of bits of the buffer size field 845 included in the BSR MAC CE 830.

FIG. 8C illustrates a format of BSR information according to an embodiment.

Referring to FIG. 8C, BSR information may be implemented as a BSR MAC CE 850 with a long BSR format.

The BSR MAC CE 850 may include at least one of an LCG i field 860, an APS i field 870, and a buffer size m field 880.

The LCG i field 860 may indicate whether a buffer size field for an LCG i exists. For example, if a field value of the LCG i field 860 is set to a first value (e.g., 1), this may indicate that the buffer size field for the LCG i is reported. For example, if the field value of the LCG i field 860 is set to a second value (e.g., 0), this may indicate that the buffer size field for the LCG i is not reported. For example, the LCG i field 860 is implemented with 8 bits, and it is indicated whether a buffer size field for LCG 0 to LCG 7 exists, as shown in FIG. 8C.

The APS i field 870 may include an APS parameter for the LCG i, and the APS parameter may be implemented similarly or substantially the same as described in Table 1 or Table 2, so a detailed description thereof will be omitted herein. For example, the APS i field 870 is implemented with 8 bits, and it is indicated whether a buffer size field for the LCG 0 to LCG 7 exists, as shown in FIG. 8C.

The buffer size m field 880 may be implemented with, for example, 8 bits, and the buffer size m field 880 may be included in the BSR MAC CE 850 in ascending order based on the LCG i. The buffer size m field 880 may indicate a buffer size for a corresponding LCG.

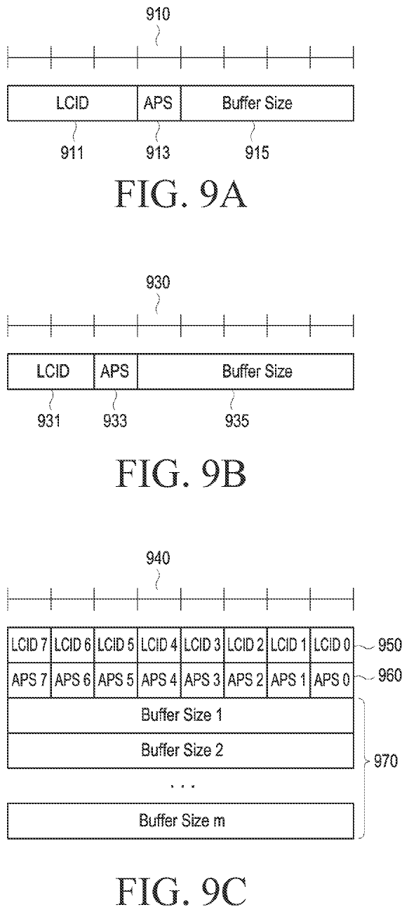

FIG. 9A illustrates a format of BSR information according to an embodiment.

Referring to FIG. 9A, BSR information may be implemented as a BSR MAC CE 910 with a short BSR format.

The BSR MAC CE 910 may include at least one of a logical channel identifier (LCID) field 911, an APS field 913, and a buffer size field 915.

The LCID field 911 may include an LCID that identifies a logical channel for which buffer status is reported. The LCID field 911 may be implemented with, for example, 3 bits.

The APS field 913 may include an APS parameter, and the APS parameter may be implemented similarly or substantially the same as described in Table 1 or Table 2, so a detailed description thereof will be omitted herein. The APS field 913 may be implemented with, for example, 1 bit.

The buffer size field 915 may indicate a total amount of available data according to a data volume calculating procedure for a corresponding logical channel after data (e.g., a MAC PDU) is generated. For example, an amount of data may be indicated by the number of bytes. A size of RLC headers and MAC subheaders is not considered when calculating a buffer size. The buffer size field 915 may be implemented with, for example, 4 bits.

FIG. 9B illustrates a format of BSR information according to an embodiment.

Referring to FIG. 9B, BSR information may be implemented as a BSR MAC CE 930 with a short BSR format.

The BSR MAC CE 930 may include at least one of an LCID field 931, an APS field 933, and a buffer size field 935.

The LCID field 931 may include an LCID that identifies a logical channel for which buffer status is reported. The LCID field 931 may be implemented with, for example, 2 bits.

The APS field 933 may include an APS parameter, and the APS parameter may be implemented similarly or substantially the same as described in Table 1 or Table 2, so a detailed description thereof will be omitted herein. The APS field 933 may be implemented with, for example, 1 bit.

The buffer size field 935 may indicate total amount of available data according to a data volume calculating procedure for a corresponding logical channel after data (e.g., a MAC PDU) is generated. For example, an amount of data may be indicated by the number of bytes. A size of RLC headers and MAC subheaders is not considered when calculating a buffer size. The buffer size field 935 may be implemented with, for example, 5 bits.

Both the BSR MAC CE 910 illustrated in FIG. 9A and the BSR MAC CE 930 illustrated in FIG. 9B may have the short BSR format. However, the number of bits of the LCID field 911 included in the BSR MAC CE 910 may be different from the number of bits of the LCID field 931 included in the BSR MAC CE 930, and the number of bits of the buffer size field 915 included in the BSR MAC CE 910 may be different from the number of bits of the buffer size field 945 included in the BSR MAC CE 930.

FIG. 9C illustrates a format of BSR information according to an embodiment.

Referring to FIG. 9C, BSR information may be implemented as a BSR MAC CE 940 with a long BSR format.

The BSR MAC CE 940 may include at least one of an LCID i field 950, an APS i field 960, and a buffer size m field 970.

The LCID i field 950 may indicate whether a buffer size field for a logical channel corresponding to the LCID i, i.e., a logical channel i exists. For example, if a field value of the LCID i field 950 is set to a first value (e.g., 1), this may indicate that the buffer size field for the logical channel i is reported. For example, if the field value of the LCID i field 950 is set to a second value (e.g., 0), this may indicate that the buffer size field for the logical channel i is not reported. For example, the LCID i field 950 is implemented with 8 bits and it is indicated whether a buffer size field for LCID 0 to LCID 7 exists, as shown in FIG. 9C.

The APS i field 960 may include an APS parameter for the logical channel corresponding to the LCID i, i.e., the logical channel i and the APS parameter may be implemented similarly or substantially the same as described in Table 1 or Table 2, so a detailed description thereof will be omitted herein. For example, the APS i field 960 is implemented with 8 bits, and it is indicated whether a buffer size field for the LCID 0 to LCID 7 exists, as shown in FIG. 9C.

The buffer size m field 970 may be implemented with, for example, 8 bits, and the buffer size m field 970 may be included in the BSR MAC CE 940 in ascending order based on the LCID i. The buffer size m field 970 may indicate a buffer size for a logical channel corresponding to a corresponding LCID.

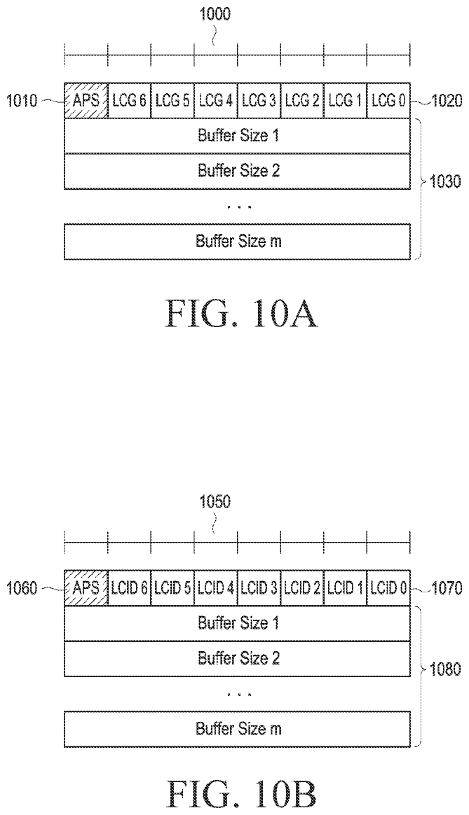

FIG. 10A illustrates a format of BSR information according to an embodiment.

Referring to FIG. 10A, BSR information may be implemented as a BSR MAC CE 1000 with a long BSR format.

The BSR MAC CE 1000 may include at least one of an APS field 1010, an LCG i field 1020, and a buffer size m field 1030.

The APS field 1010 may include an APS parameter for an LCG i corresponding to the LCG i field 1020 when data (e.g., a MAC PDU) is generated by a plurality of applications. For example, if the LCG i field 1020 is implemented with 7 bits, APS parameters for an LCG 0 to an LCG 6 may be the same, and the APS parameters for the LCG 0 to the LCG 6 may be included in the APS field 1010.

The LCG i field 1020 may indicate whether a buffer size field for the LCG i exists. For example, if a field value of the LCG i field 1020 is set to a first value (e.g., 1), this may indicate that the buffer size field for the LCG i is reported. If the field value of the LCG i field 1020 is set to a second value (e.g., 0), this may indicate that the buffer size field for the LCG i is not reported. For example, the LCG i field 1020 is implemented with 7 bits and it is indicated whether a buffer size field for LCG 0 to LCG 7 exists, as shown in FIG. 10A.

The buffer size m field 1030 may be implemented with, for example, 8 bits, and the buffer size m field 1030 may be included in the BSR MAC CE 1000 in ascending order based on the LCG i. The buffer size m field 1030 may indicate a buffer size for a corresponding LCG.

FIG. 10B illustrates a format of BSR information according to an embodiment.

Referring to FIG. 10B, BSR information may be implemented as a BSR MAC CE 1050 with a long BSR format.

The BSR MAC CE 1050 may include at least one of an APS field 1060, an LCID i field 1070, and a buffer size m field 1080.

The APS field 1060 may include an APS parameter for a logical channel corresponding to an LCID i corresponding to the LCID i field 1070 when data (e.g., a MAC PDU) is generated by a plurality of applications. For example, if the LCID i field 1070 is implemented with 7 bits, APS parameters for an LCID 0 to an LCID 6 may be the same, and the APS parameters for the LCID 0 to the LCID 6 may be included in the APS field 1060.

The LCID i field 1070 may indicate whether a buffer size field for the logical channel corresponding to the LCID i, i.e., a logical channel i exists. For example, if a field value of the LCID i field 1070 is set to a first value (e.g., 1), this may indicate that the buffer size field for the logical channel i is reported. If the field value of the LCID i field 1070 is set to a second value (e.g., 0), this may indicate that the buffer size field for the logical channel i is not reported. For example, the LCID i field 1070 is implemented with 7 bits and it is indicated whether a buffer size field for LCID 0 to LCID 7 exists, as shown in FIG. 10B.

The buffer size m field 1080 may be implemented with, for example, 8 bits, and the buffer size m field 1080 may be included in the BSR MAC CE 1050 in ascending order based on the LCID i. The buffer size m field 1080 may indicate a buffer size for a logical channel corresponding to a corresponding LCID.

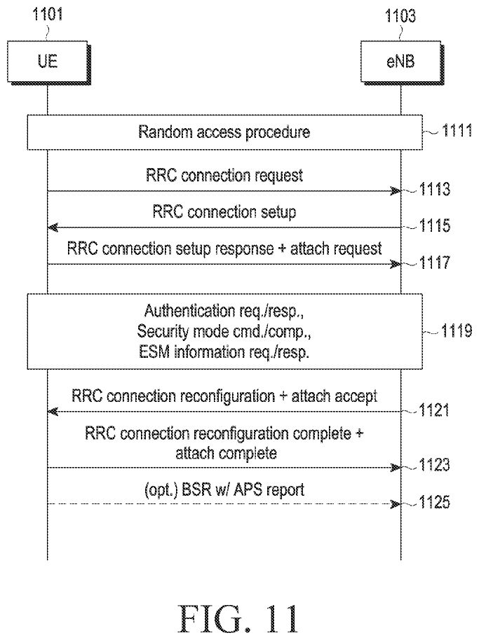

FIG. 11 illustrates a procedure between a UE and an eNB for providing APS information in a wireless communication system according to an embodiment.

Referring to FIG. 11, a UE 1101 (e.g., one of a plurality of UEs 111, 112, 113, 114, 115, 116 in FIG. 1 or a UE 116 in FIG. 3) in an RRC_IDLE state may perform a random access procedure with an eNB 1103 (e.g., one of a plurality of base stations 101, 102, 103 in FIG. 1, or a base station 102 in FIG. 2) to perform a CA operation or a DC operation in step 1111.

After performing the random access procedure with the base station 1103, the UE 1101 may transmit, to the eNB 1103, an RRC connection request message to set up an RRC connection in step 1113. After receiving the RRC connection request message from the UE 1101, the eNB 1103 may transmit, to the UE 1101, an RRC connection setup message requesting to set up the RRC connection in response to the RRC connection request message in step 1115.

After receiving the RRC connection setup message from the eNB 1103, the UE 1101 may transmit, to the eNB 1103, an RRC connection setup response message and an attach request message in response to the RRC connection setup message in step 1117.

After receiving the RRC connection setup response message and the attach request message from the UE 1101, the eNB 1103 may perform operations related to an initial attach such as an authentication procedure, a security mode command procedure, and/or an evolved packet system (EPS) session management (ESM) procedure with the UE 1101 in step 1119. The authentication procedure may be performed by exchanging an authentication request message and/or an authentication response message between the UE 1101 and the eNB 1103. The security mode command procedure may be performed by exchanging a security mode command message and/or a security mode command complete message between the UE 1101 and the eNB 1103. The ESM procedure may be performed by exchanging an ESM information request message and/or an ESM information response message between the UE 1101 and the eNB 1103.

After performing the operations related to the initial attach such as the authentication procedure, the security mode command procedure, and/or the ESM procedure with the UE 1101, the eNB 1103 may transmit, to the UE 1101, an RRC connection reconfiguration message and an attach accept message in response to the RRC connection setup response message and the attach request message in step 1121.

After receiving the RRC connection reconfiguration message and the attach accept message from the eNB 1103, the UE 1101 may transmit, to the eNB 1103, an RRC connection reconfiguration complete message and an accept complete message in response to the RRC connection reconfiguration message and the attach accept message in step 1123.

The UE 1101 may provide, via UE capability information, the eNB 1103 with information about whether the UE 1101 supports an APS report (for example, information about whether the UE 1101 supports a BSR with an APS report (hereinafter, referred to as “BSR w/APS report”)). For example, the UE capability information may be provided to the eNB 1103 via a UE capability information (UECapabilitylnformation) message during a UE capability transfer procedure. In this case, the eNB 1103 may provide configuration related to the BSR w/APS report via an RRC connection reconfiguration message in step 1121. The configuration related to the BSR w/APS report may include information related to a period for transmitting the BSR w/APS report, information related to an event that is a condition for transmitting the BSR w/APS report, and information related to a timer for transmitting the BSR w/APS report. The configuration related to the BSR w/APS report may include information indicating whether it is required to transmit the BSR w/APS report. If it is not required to transmit the BSR w/APS report, the configuration related to the BSR w/APS report may not include the information related to the period for transmitting the BSR w/APS report, the information related to the event that is the condition for transmitting the BSR w/APS report, and the timer for transmitting the BSR w/APS report.

Alternatively, if it is mandatory for the UE 1101 to perform the APS report, the UE 1101 may not need to provide, via the UE capability information, the eNB 1103 with the information about whether the UE 1101 supports the APS report. In this case, the eNB 1103 may provide the configuration related to the BSR w/APS report via the RRC connection setup message in step 1115, or provide the configuration related to the BSR w/APS report via the RRC connection reconfiguration message in step 1121.

Meanwhile, although not separately shown in FIG. 11, the eNB 1103 may provide the configuration related to BSR w/APS report via a MAC CE. In this case, the eNB 1103 may use one of reserved values (e.g., 37 to 42) among values of an LCID for a UL shared channel (UL-SCH) as the information indicating whether it is required to transmit the BSR w/APS report. The values of the LCID for the UL-SCH may be shown below in Table 3. Alternatively, the eNB 1103 may use the one of the reserved values (e.g., 37 to 42) among the values of the LCID for the UL-SCH as information indicating whether it is required to transmit the BSR w/APS report or it is required to transmit a BSR according to an embodiment.

TABLE 3

| Codepoint/Index | LCID values |
|---|---|
| 0 | CCCH of size 64 bits (referred to as “CCCH1” in |
| | TS 38.331), except for a RedCap UE |
| 1-32 | Identity of the logical channel of DCCH and DTCH |
| 33 | Extended logical channel ID field (two-octet eLCID |
| | field) |
| 34 | Extended logical channel ID field (one-octet eLCID |
| | field) |
| 35 | CCCH of size 48 bits (referred to as “CCCH” in |
| | TS 38.331) for a RedCap UE |
| 36 | CCCH of size 64 bits (referred to as “CCCH1” in |
| | TS 38.331) for a RedCap UE |
| 37-42 | Reserved |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” in |
| | TS 38.331), except for a RedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

If the wireless communication system is based on a new radio (NR) scheme, the attach request message, the attach accept message, and the attach complete message described in FIG. 11 may be replaced with a registration request message, a registration accept message, and a registration complete message, respectively. In addition, messages used in a procedure between a UE and an eNB for providing APS information proposed in the disclosure may be replaced with not only the messages described in FIG. 11 but also other messages supported by a wireless communication system or new separate messages.

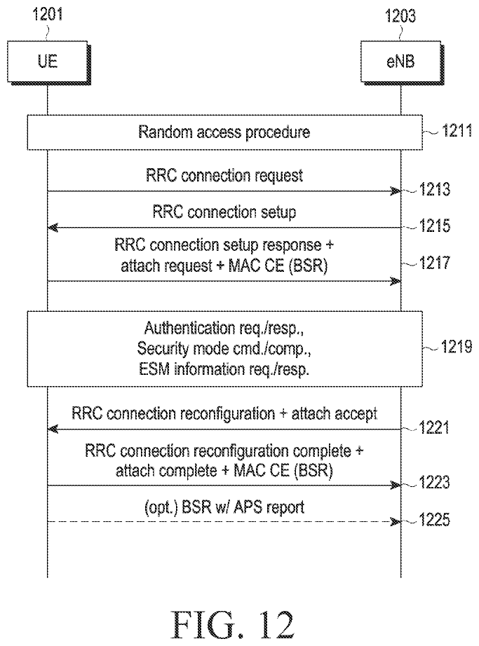

FIG. 12 illustrates a procedure between a UE and an eNB for providing APS information in a wireless communication system according to an embodiment.

Referring to FIG. 12, a procedure for providing APS information between a UE 1201 (e.g., one of a plurality of UEs 111, 112, 113, 114, 115, and 116 in FIG. 1, a UE 116 in FIG. 3, or a UE 1101 in FIG. 11) and an eNB 1203 (e.g., one of a plurality of base stations 101, 102, and 103 in FIG. 1, a base station 102 in FIG. 2, or an eNB 1103 in FIG. 11) shown in FIG. 12 may be implemented similarly to or substantially the same as a procedure for providing APS information described in FIG. 11, so a detailed description thereof will be omitted herein. However, in FIG. 12, compared to FIG. 11, an operation in which the UE 1201 transmits a BSR w/APS report via a MAC CE or a separate RRC message is additionally explained. That is, steps 1211, 1213, 1215, 1219, and 1221 in FIG. 12 may be implemented similarly to or substantially the same as steps 1111, 1113, 1115, 1119, and 1121 in FIG. 11, so steps 1217, 1223, and 1225 are additionally described as follows.

If it is mandatory for the UE 1201 to perform an APS report, the UE 1201 may not need to provide the eNB 1203 with information about whether the UE 1201 supports the APS report via UE capability information. In this case, the eNB 1203 may provide configuration related to a BSR w/APS report via an RRC connection setup message in step 1215. In this case, the UE 1201 may transmit APS information of the UE 1201 to the eNB 1203 by transmitting the BSR w/APS report via a MAC CE on a physical UL shared channel (PUSCH) where the RRC connection setup response message is transmitted in step 1217. The UE 1201 may transmit the BSR w/APS report via the MAC CE as described in one of FIG. 8A, 8B, 8C, 9A, 9B, 9C, 10A, or 10B.

If it is mandatory for the UE 1201 to perform the APS report, the eNB 1203 may provide configuration related to the BSR w/APS report via an RRC connection reconfiguration message in step 1221 even though the UE 1201 does not provide the information about whether the UE 1201 supports the APS report via the UE capability information. In this case, the UE 1201 may transmit the APS information of the UE 1201 to the eNB 1203 by transmitting the BSR w/APS report via a MAC CE on a PUSCH where an RRC connection reconfiguration complete message is transmitted in step 1223. The UE 1201 may transmit the BSR w/APS report via the MAC CE as described in one of FIG. 8A, 8B, 8C, 9A, 9B, 9C, 10A, or 10B.

Alternatively, if it is optional for the UE 1201 to perform the APS report, the UE 1201 may provide the eNB 1203 with the information about whether the UE 1201 supports the APS report (for example, whether the UE 1201 supports the BSR w/APS report) via the UE capability information. In this case, the eNB 1203 may provide the configuration related to the BSR w/APS report via the RRC connection reconfiguration message in step 1221. In this case, the UE 1201 may transmit the APS information of the UE 1201 to the eNB 1203 by transmitting the BSR w/APS report via the MAC CE on the PUSCH where the RRC connection reconfiguration complete message is transmitted in step 1223. The UE 1201 may transmit the BSR w/APS report via the MAC CE as described in one of FIG. 8A, 8B, 8C, 9A, 9B, 9C, 10A, or 10B.

Alternatively, although not separately shown in FIG. 12, the eNB 1203 may provide the configuration related to the BSR w/APS report via the MAC CE. In this case, the UE 1201 may transmit the APS information of the UE 1201 to the eNB 1203 by transmitting the BSR w/APS report via the MAC CE on the PUSCH where the RRC connection setup response message is transmitted in step 1217, or transmit the APS information of the UE 1201 to the eNB 1203 by transmitting the BSR w/APS report via the MAC CE on the PUSCH where the RRC connection reconfiguration complete message is transmitted in step 1223. The UE 1201 may transmit the BSR w/APS report via the MAC CE as described in one of FIG. 8A, 8B, 8C, 9A, 9B, 9C, 10A, or 10B.

Alternatively, when receiving a message requesting to transmit the BSR w/APS report from the eNB 1203, the UE 1201 may transmit the APS information of the UE 1201 to the eNB 1203 by transmitting the BSR w/APS report via at least one of a separate RRC message, the MAC CE, or unlink control information (UCI) in step 1225. The UE 1201 may transmit the BSR w/APS report via the MAC CE as described in one of FIG. 8A, 8B, 8C, 9A, 9B, 9C, 10A, or 10B. In FIG. 12, step 1225 is shown after step 1223, but operation 1225 may be performed at any time point before step 1223.

Alternatively, even if the UE 1201 does not receive the message requesting to transmit the BSR w/APS report from the eNB 1203, the UE 1201 may transmit the APS information of the UE 1201 to the eNB 1203 by transmitting the BSR w/APS report via at least one of the separate RRC message, the MAC CE, or the UCI in step 1225. In FIG. 12, operation 1225 is shown after step 1223, but may be performed at any time point before step 1223.

Alternatively, as the UE 1201 transits from an RRC_IDLE state into an RRC_CONNECTED state in step 1223, the UE 1201 may transmit the APS information of the UE 1201 to the eNB 1203 by transmitting the BSR w/APS report via the at least one of the separate RRC message, the MAC CE, or the UCI in step 1225. In this case, the eNB 1203 may perform CA and/or DC operations based on the BSR w/APS report of the UE 1201 which is in the RRC_CONNECTED state.

If the wireless communication system is based on an NR scheme, the attach request message, the attach accept message, and the attach complete message described in FIG. 12 may be replaced with a registration request message, a registration accept message, and a registration complete message, respectively. In addition, messages used in a procedure between a UE and an eNB for providing APS information proposed in the disclosure may be replaced with not only the messages described in FIG. 12 but also other messages supported by a wireless communication system or new separate messages.

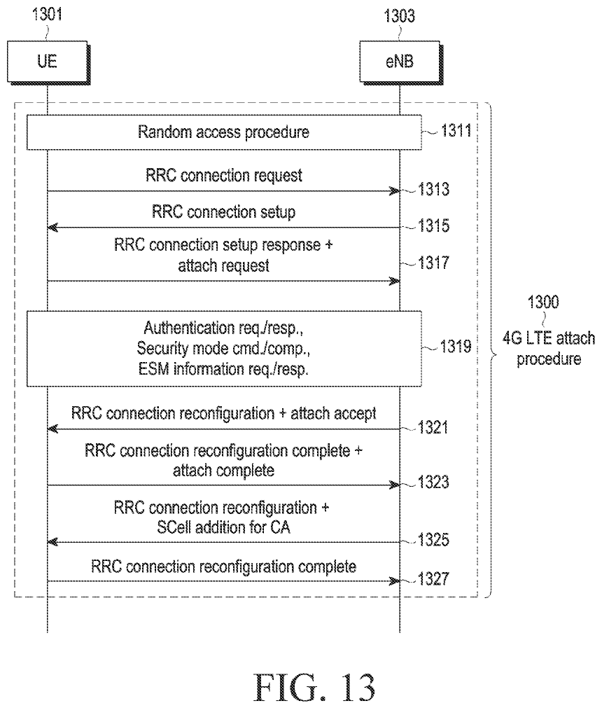

FIG. 13 illustrates an SCell addition procedure for a CA operation and/or a DC operation in a wireless communication system according to an embodiment.

Referring to FIG. 13, a UE 1301 (e.g., one of a plurality of UEs 111, 112, 113, 114, 115, and 116 in FIG. 1, a UE 116 in FIG. 3, a UE 1101 in FIG. 11, or a UE 1201 in FIG. 12) which is in an RRC_IDLE state may perform an SCell addition procedure 1300 for a CA operation and/or a DC operation with an eNB 1303 (e.g., one of a plurality of base stations 101, 102, and 103 in FIG. 1, a base station 102 in FIG. 2, an eNB 1103 in FIG. 11, or an eNB 1203 in FIG. 12). The SCell addition procedure 1300 may correspond to a 4G LTE attach procedure. Steps 1311 to 1323 of the SCell addition procedure 1300 performed between the UE 1301 and the eNB 1303 may be implemented similarly to or substantially the same as steps 1211 to 1223 described in FIG. 12, so a detailed description thereof will be omitted herein.

When receiving an RRC connection reconfiguration complete message, an attach complete message, and a MAC CE including a BSR w/APS report from the UE 1301, the eNB 1303 may identify APS information for the UE 1301 based on the received MAC CE. An SCell addition operation may be performed based on the identified APS information.

For example, if a value of an APS parameter is a first value (e.g., 0), this indicates that data is generated by a single application in a background process (e.g., as shown in Table 1), or the data is generated by a plurality of applications in the background process (e.g., as shown in Table 2). So, the eNB 1303 may determine not to transmit the RRC reconfiguration message for the CA operation and/or the DC operation in consideration of battery consumption of the UE 1301. Alternatively, even though the value of the APS parameter is the first value (e.g., 0), the eNB 1303 may transmit the RRC reconfiguration message for the CA operation and/or the DC operation without considering the battery consumption of the UE 1301.

If the value of the APS parameter is a second value (e.g., 1), this may indicate that data is generated by a single application in a foreground process (e.g., as shown in Table 1). If the value of the APS parameter is the second value (e.g., 1), this may indicate that the data is generated by at least one of a plurality of applications in the foreground process, or the data is generated by the plurality of applications in the background process, and a foreground process (which does not generate data) is running simultaneously (e.g., as shown in Table 2). So, the eNB 1303 may determine to transmit the RRC reconfiguration message for the CA operation and/or the DC operation.

Similarly, the eNB 1303 may determine whether to transmit the RRC reconfiguration message for the CA operation and/or the DC operation based on the APS information of the UE 1301, so an efficient network operation may be possible. In this case, the UE 1301 may not need to maintain a unnecessary SCell due to the CA operation and/or the DC operation, so unnecessary power consumption of the UE 1301 may also be reduced (or prevented).

When determining to perform the SCell addition operation based on the APS information, the eNB 1303 may transmit the RRC reconfiguration message and an SCell addition message to the UE 1301 in step 1325. When receiving the RRC reconfiguration message and the SCell addition message from the eNB 1303, the UE 1301 may transmit an RRC connection reconfiguration complete message in response to the RRC reconfiguration message and the SCell addition message in step 1327.

If the wireless communication system is a wireless communication system based on an NR scheme, the attach request message, the attach accept message, and the attach complete message described in FIG. 13 may be replaced with a registration request message, a registration accept message, and a registration complete message, respectively. In addition, messages used in a procedure between a UE and an eNB for providing APS information proposed in the disclosure may be replaced with not only the messages described in FIG. 13 but also other messages supported by a wireless communication system or new separate messages.

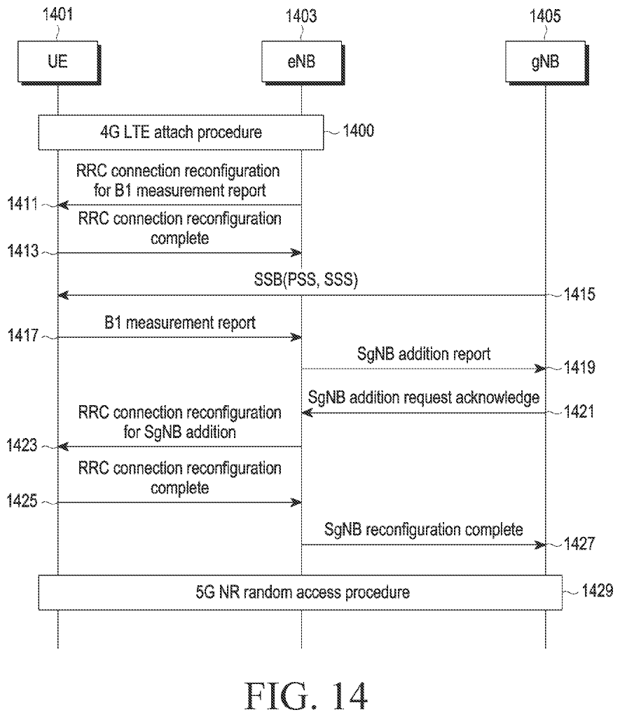

FIG. 14 illustrates an SgNB addition procedure for a CA operation and/or a DC operation in a wireless communication system according to an embodiment.

Referring to FIG. 14, a UE 1401 (e.g., one of a plurality of UEs 111, 112, 113, 114, 115, and 116 in FIG. 1, a UE 116 in FIG. 3, a UE 1101 in FIG. 11, a UE 1201 in FIG. 12, or a UE 1301 in FIG. 13) which is in an RRC_IDLE state may perform an SgNB addition procedure for a CA operation and/or a DC operation with an eNB 1403 (e.g., one of a plurality of base stations 101, 102, and 103 in FIG. 1, a base station 102 in FIG. 2, an eNB 1103 in FIG. 11, an eNB 1203 in FIG. 12, or an eNB 1303 in FIG. 13). A 4G LTE access procedure 1400 in the SgNB addition procedure performed between the UE 1401 and the eNB 1403 may be implemented similarly to a 4G LTE access procedure 1300 described in FIG. 13, so a detailed description thereof will be omitted herein.

As the 4G LTE connection procedure 1400 is performed, the UE 1401 may transit from an RRC_IDLE state to an RRC_CONNECTED state, and immediately after the UE 1401 transits from the RRC_IDLE state to the RRC_CONNECTED state, the eNB 1403 may perform a radio resource management (RRM) operation based on APS information received from the UE 1401 during the 4G LTE connection procedure 1400.

For example, if a value of an APS parameter is a first value (e.g., 0), this indicates that data is generated by a single application in a background process (e.g., as shown in Table 1), or the data is generated by a plurality of applications in the background process (e.g., as shown in Table 2). So, the eNB 1403 may increase a transmission period for each of a CSI reference signal (CSI-RS), a CSI report, a tracking reference signal (TRS), and a sounding reference signal (SRS).

If the value of the APS parameter is a second value (e.g., 1), this may indicate that data is generated by a single application in a foreground process (e.g., as shown in Table 1). If the value of the APS parameter is the second value (e.g., 1), this may indicate that the data is generated by at least one of a plurality of applications in the foreground process, or the data is generated by the plurality of applications in the background process, and a foreground process (which does not generate data) is running simultaneously (e.g., as shown in Table 2). So, the eNB 1403 may maintain or reduce the transmission period for each of the CSI-RS, the CSI report, the TRS, and the SRS.

In this process, the eNB 1403 may efficiently allocate limited physical UL control channel (PUCCH) resources and SRS resources based on the APS information received from the UE 1401.

After performing the 4G LTE access procedure 1400, the eNB 1403 may generate an RRC connection reconfiguration message for a B1 measurement report based on the APS information received from the UE 1401 in step 1411, and transmit the generated RRC connection reconfiguration message to the UE 1401 in step 1413. In this case, the UE 1401 may also perform a measurement reporting operation based on efficiently allocated CSI-RS, TRS, and SRS resources.

When receiving the RRC connection reconfiguration message from the eNB 1403, the UE 1401 may transmit an RRC connection reconfiguration complete message in response to the RRC connection reconfiguration message to the eNB 1403 in step 1413. After transmitting the RRC connection reconfiguration complete message, the UE 1401 may receive a synchronization signal (SS)/physical broadcast channel (PBCH) block (SSB) from the gNB 1405 in step 1415. After receiving the SSB from the gNB 1405, the UE 1401 may transmit a B1 measurement report message in step 1417. Here, the B1 measurement report message may be generated based on the RRC connection reconfiguration message in step 1411 generated based on the APS information of the UE 1401.

When receiving the B1 measurement report message from the UE 1401, the eNB 1403 may transmit, to the gNB 1405, an SgNB addition request message requesting to add an SgNB for the UE 1401 in step 1419. After receiving the SgNB addition request message from the eNB 1403, the gNB 1405 may transmit an SgNB addition request acknowledge message in response to the SgNB addition request message in step 1421.

After receiving the SgNB addition request acknowledge message from the gNB 1405, the eNB 1403 may transmit an RRC connection reconfiguration message for SgNB addition to the UE 1401 in step 1423. After receiving the RRC connection reconfiguration message for SgNB addition from the eNB 1403, the UE 1401 may transmit an RRC connection reconfiguration complete message to the eNB 1403 in response to the RRC connection reconfiguration message in step 1425.

After receiving the RRC connection reconfiguration complete message from the UE 1401, the eNB 1403 may transmit an SgNB reconfiguration complete message to the gNB 1405 in step 1427. Then, a 5G NR random access procedure may be performed between the UE 1401 and the gNB 1405 in step 1429.

Various functions described herein can be implemented or supported by one or more computer programs, each of which is formed from computer readable program code and embodied in a computer readable medium. The terms application and program refer to one or more computer programs, software components, sets of instructions, procedures, functions, objects, classes, instances, related data, or a portion thereof adapted for implementation in a suitable computer readable program code. The phrase computer readable program code includes any type of computer code, including source code, object code, and executable code. The phrase computer readable medium includes any type of medium capable of being accessed by a computer, such as read only memory (ROM), random access memory (RAM), a hard disk drive, a compact disc (CD), a digital video disc (DVD), or any other type of memory. A non-transitory computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used in connection with various embodiments of the disclosure, the term module may include a unit implemented in hardware, software, or firmware, and may interchangeably be used with other terms, for example, logic, logic block, part, or circuitry. A module may be a single integral component, or a minimum unit or part thereof, adapted to perform one or two or more functions. For example, the module may be implemented as an application-specific integrated circuit (ASIC).

Various embodiments of the disclosure may be implemented as software (e.g., a program) including one or more instructions that are stored in a storage medium (e.g., internal memory or external memory) that is readable by a machine (e.g., an electronic device). For example, a processor of the machine (e.g., the electronic device) may invoke at least one of the one or more instructions stored in the storage medium and execute it. This enables the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

A method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be performed sequentially, in parallel, repeatedly, or heuristically, or one or more of the operations may be executed in a different order or omitted, or one or more other operations may be added.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A terminal, comprising:
a transceiver; and
a processor operably connected to the transceiver,
wherein the processor is configured to:
generate application process state (APS) information indicating whether data generated by at least one application of the terminal is data generated in a background process or data generated in a foreground process, and
transmit, via the transceiver, to a base station, a control signal including the APS information.

2. The terminal of claim 1,
wherein the processor is further configured to receive, via the transceiver, from the base station, a message including configuration information related to transmitting the control signal.

3. The terminal of claim 1,
wherein the at least one application includes a single application, and the APS information is for a logical channel identifier (LCID) or a logical channel group identifier (LCG ID).

4. The terminal of claim 1,
wherein the at least one application includes a plurality of applications, and, if the APS information indicates the data generated in the background process, the data generated in the background process is data generated by the plurality of applications in the background process, and
wherein the APS information is for a logical channel identifier (LCID) or a logical channel group identifier (LCG ID).

5. The terminal of claim 1,
wherein the at least one application includes a plurality of applications, and, if the APS information indicates the data generated in the foreground process, the data generated in the foreground process is data generated by the plurality of applications in the foreground process, and
wherein the APS information is for a logical channel identifier (LCID) or a logical channel group identifier (LCG ID).

6. The terminal of claim 1,
wherein the at least one application includes a plurality of applications, and, if the APS information indicates the data generated in the background process, the data generated in the background process is data generated by the plurality of applications in the background process,
wherein the foreground process is running and does not generate data, and
wherein the APS information is for a logical channel identifier (LCID) or a logical channel group identifier (LCG ID).

7. The terminal of claim 1, wherein the control signal includes a medium access control (MAC) control element (CE), and
wherein the MAC CE includes:
a first field indicating a logical channel group (LCG) identifier (ID) of an LCG corresponding to the APS information,
a second field indicating the APS information, and
a third field indicating a buffer size of the LCG.

8. The terminal of claim 1, wherein the control signal includes a medium access control (MAC) control element (CE),
wherein the MAC CE includes:
a first field indicating whether a third field indicating a buffer size exists for each of logical channel groups (LCGs) corresponding to the APS information, and
a second field indicating APS information for each of the LCGs, and
wherein, if the first field indicates that the third field exists for each of the LCGs corresponding to the APS information, the MAC CE further includes the third field.

9. The terminal of claim 1, wherein the control signal includes a medium access control (MAC) control element (CE), and
wherein the MAC CE includes:
a first field indicating a logical channel identifier (LCID) of a logical channel corresponding to the APS information,
a second field indicating the APS information, and
a third field indicating a buffer size of the logical channel.

10. The terminal of claim 1, wherein the control signal includes a medium access control (MAC) control element (CE), and
wherein the MAC CE includes:
a first field indicating whether a third field indicating a buffer size exists for each of logical channels corresponding to the APS information, and
a second field indicating APS information for each of the logical channels, and
wherein, if the first field indicates that the third field exists for each of the logical channels corresponding to the APS information, the MAC CE further includes the third field.

11. A method performed by a terminal, the method comprising:
generating application process state (APS) information indicating whether data generated by at least one application of the terminal is data generated in a background process or data generated in a foreground process; and
transmitting a control signal including the APS information to a base station.

12. The method of claim 11, further comprising receiving, from the base station, a message including configuration information related to transmitting the control signal.

13. The method of claim 11,
wherein the at least one application includes a single application, and the APS information is for a logical channel identifier (LCID) or a logical channel group (LCG) identifier (ID).

14. The method of claim 11,
wherein the at least one application includes a plurality of applications, and, if the APS information indicates the data generated in the background process, the data generated in the background process is data generated by the plurality of applications in the background process, and
wherein the APS information is for a logical channel identifier (LCID) or a logical channel group (LCG) identifier (ID).

15. The method of claim 11,
wherein the at least one application is a plurality of applications, and, if the APS information indicates the data generated in the foreground process, the data generated in the foreground process is data generated by the plurality of applications in the foreground process, and
wherein the APS information is for a logical channel identifier (LCID) or a logical channel group (LCG) identifier (ID).

16. The method of claim 11,
wherein the at least one application is a plurality of applications, and, if the APS information indicates data generated in the background process, the data generated in the background process is data generated by the plurality of applications in the background process,
wherein the foreground process is running and does not generate data, and
wherein the APS information is for a logical channel identifier (LCID) or a logical channel group (LCG) identifier (ID).

17. The method of claim 11, wherein the control signal includes a medium access control (MAC) control element (CE), and
wherein the MAC CE includes:
a first field indicating a logical channel group (LCG) identifier (ID) of an LCG corresponding to the APS information,
a second field indicating the APS information, and
a third field indicating a buffer size of the LCG.

18. The method of claim 11, wherein the control signal includes a medium access control (MAC) control element (CE),
wherein the MAC CE includes:
a first field indicating whether a third field indicating a buffer size exists for each of logical channel groups (LCGs) corresponding to the APS information, and
a second field indicating APS information for each of the LCGs, and
wherein, if the first field indicates that the third field exists for each of the LCGs corresponding to the APS information, the MAC CE further includes the third field.

19. The method of claim 11, wherein the control signal includes a medium access control (MAC) control element (CE), and
wherein the MAC CE includes:
a first field indicating a logical channel identifier (LCID) of a logical channel corresponding to the APS information,
a second field indicating the APS information, and
a third field indicating a buffer size of the logical channel.

20. The method of claim 11, wherein the control signal includes a medium access control (MAC) control element (CE), and
wherein the MAC CE includes:
a first field indicating whether a third field indicating a buffer size exists for each of logical channels corresponding to the APS information, and
a second field indicating APS information for each of the logical channels, and
wherein, if the first field indicates that the third field exists for each of the logical channels corresponding to the APS information, the MAC CE further includes the third field.
